(19) United States
(12) Patent Application Publication
(10) Pub. No.: US 2011/0200768 A1
(43) Pub. Date: Aug. 18, 2011

(54) CORRUGATE BOARD

(75) Inventors: Richard Revell, Liverpool (GB); Chris Hallam, Liverpool (GB)

(73) Assignees: CONCEPT PACKAGING SERVICES LIMITED, Bradford (GB); POLYTECNICA LIMITED, Baildon (GB)

(21) Appl. No.: 13/026,746

(22) Filed: Feb. 14, 2011

(30) Foreign Application Priority Data
Feb. 12, 2010 (GB) 1002393.5

(51) Int. Cl. B32B 29/08; B32B 1/00; B23P 11/00

(52) U.S. Cl. 428/34.2; 428/182; 428/195.1; 29/428

(57) ABSTRACT

A corrugate board construction including a first outer layer, a flute layer and a second outer layer, wherein the second outer layer has been secured to the flute after the first outer layer, wherein the external layer is the first outer layer.

### BACKGROUND OF THE INVENTION

The present invention relates to corrugate board, to corrugate board constructions and to methods of constructing the same.

In conventional corrugate board manufacture a corrugate board comprises a first outer layer bonded to a flute and a second outer layer bonded to the opposite side of the flute to the first outer layer. When the board is to be printed on, for instance in packaging applications, it is the second outer layer that is treated as the primary printable surface, to be printed to, because the application of the second outer layer is done under less aggressive conditions of temperature and/or pressure, so the surface of the second outer layer is not treated as harshly as the first outer layer. Accordingly, the relatively fragile printable layer is applied as the second outer layer.

### SUMMARY OF THE INVENTION

According to the present invention in a first aspect, there is provided a corrugate board construction comprising a first outer layer, a flute layer and a second outer layer, wherein the second outer layer has been secured to the flute after the first outer layer, wherein the external layer is the first outer layer.

Suitably, the flute layer has a flute direction construction the axis of curvature is perpendicular to the flute direction.

Suitably, the corrugate board construction is a box, tube or carton construction. In any made-up construction the external layer is self-evident. It will be appreciated that a box need not be cuboidal. For instance a box construction could be oval in cross section.

Suitably, the first outer layer is substantially denser than the second outer layer. Suitably, the first outer layer is at least 50 g/m², more suitably at least 60 g/m², preferably at least 70 g/m² and more preferably at least 80 g/m² denser than the second outer layer.

Suitably, the corrugate board is according to the third aspect of the invention.

Being able to provide a viable curvable corrugate that can have a radius of curvature of under 0.1 metre is surprising in itself.

According to the present invention in a second aspect, there is provided a method of construction of a corrugate board construction, the method comprising the steps of:
a) providing a first outer layer;
b) providing a flute layer;
c) providing a second outer layer;
d) securing the first outer layer to the flute layer;
e) after the first outer layer is secured to the flute layer, securing the second outer layer to the flute layer; and
f) using the corrugate board to construct a corrugate board construction.

Suitably, the method of construction of the corrugate board is according to the fourth aspect of the present invention.

According to the present invention in a third aspect, there is provided a corrugate board comprising a first outer layer, a flute layer and a second outer layer, wherein the second outer layer has been secured to the flute after the first outer layer and the first outer layer is suitable for printing.

Suitably, the first outer layer is the primary printable layer.

Suitably, the first outer layer comprises a printable coating.

Suitably, the first outer layer further comprises a printed layer applied thereto.

Suitably, the flute layer is G flute.

According to the present invention in a fourth aspect, there is provided a method of construction of a corrugate board, the method comprising the steps of:
a) providing a first outer layer, which is a layer suitable for printing;
b) providing a flute layer;
c) providing a second outer layer;
d) securing the first outer layer to the flute layer; and
e) after the first outer layer is secured to the flute layer, securing the second outer layer to the flute layer.

Suitably, the method further comprises printing a layer onto the first outer layer.

Suitably, the method comprises securing the first outer layer to the flute layer in a distributed pressure process. Suitably, the first outer layer is secured to the flute layer by the application of pressure from a pressure belt and a corrugated roller. Suitably, the pressure belt extends between at least two rollers.

Suitably, the first outer layer is not heated to beyond ambient temperature before being provided to the flute layer.

Suitably, the second outer layer is secured to the flute layer at a heater temperature not exceeding 170′C, more suitably not exceeding 160° C., preferably not exceeding 150° C. and most preferably not exceeding 140° C.

Suitably, the corrugate board is left to dry for less than 3 days, more suitably less than 2½ days, preferably for less than 2 days and most preferably for less than 1½ days.

Suitably, the corrugate board is used for construction of a corrugate board construction, which is preferably a carton.

### BRIEF DESCRIPTION OF THE DRAWINGS

For a better understanding of the invention, and to show how embodiments of the same may be carried into effect, reference will now be made, by way of example, to the accompanying diagrammatic drawings in which:

FIG. 1 is a front elevation of a known corrugate board construction.

FIG. 2 is an enlarged cross-sectional illustration of the corrugate board of FIG. 1 along the line A-A.

FIG. 3 is a front elevation of a corrugate board construction according to the present invention.

FIG. 4 is an enlarged cross-sectional illustration of the corrugate board of FIG. 1 along the line B-B.

FIG. 5 is a view corresponding to FIG. 3 with the first outer layer carrying an applied print.

FIG. 6 is a perspective view of a corrugate board construction according to the present invention.

FIG. 7 is a schematic illustration of part of a modul facer forming part of an apparatus for manufacturing a corrugate board according to the present invention.

FIG. 8 is a schematic illustration of a double facer forming part of an apparatus for manufacturing a corrugate board according to the present invention.

FIG. 9 is a flow chart illustrating steps in a method of manufacturing a corrugate board according to the present invention.

### DETAILED DESCRIPTION OF THE INVENTION

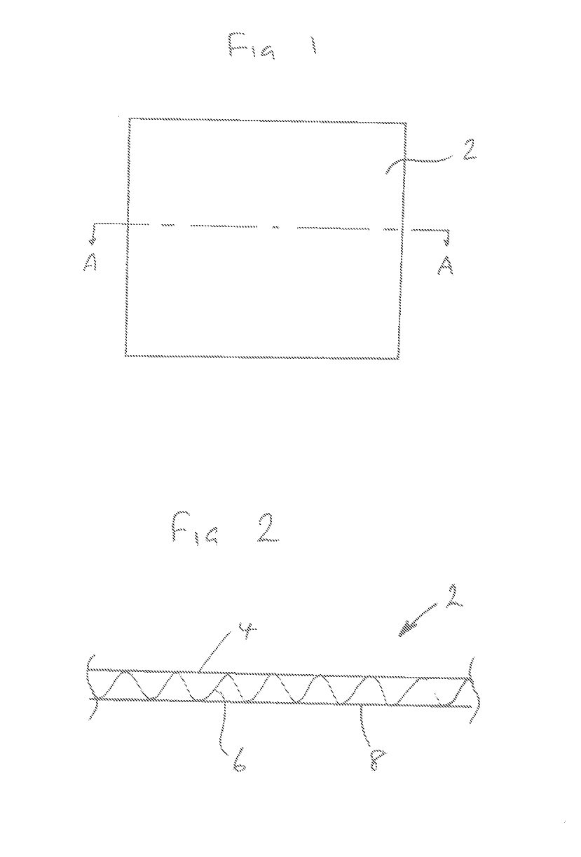

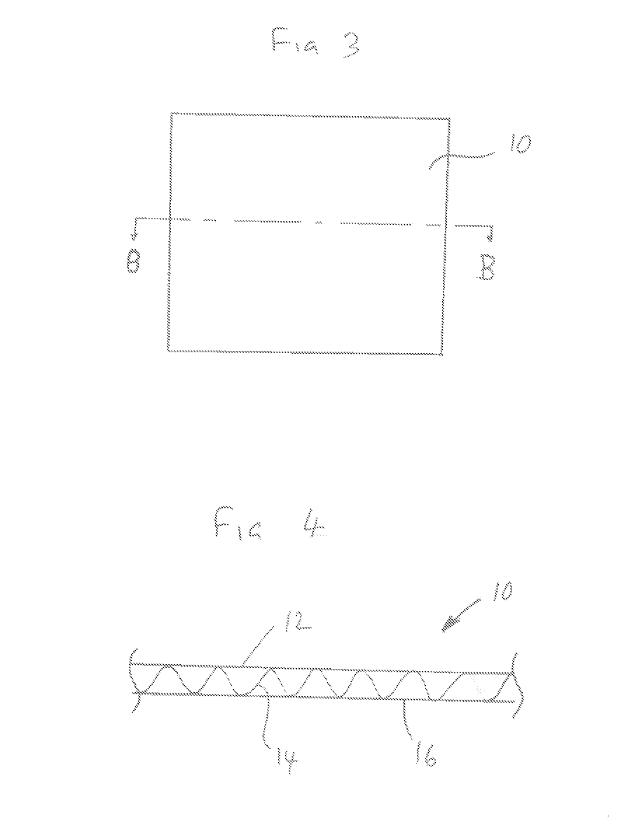

Referring to FIGS. 1 and 2 of the accompanying drawings, there is shown a corrugate board 2 of conventional manufacture comprising a first outer layer 4, a flute layer 6 and a second outer layer 8. The first outer layer 4 is the first layer secured to the flute layer 6 in the manufacturing process by applying heat and pressure to the first outer layer 4 and the flute layer 6 using a nip roller. In this case the board thickness is approximately 1 millimetre. The direction of the flutes is vertical in FIG. 1 and perpendicular to the plane of the paper in FIG. 2.

According to the existing state of the art, the second outer layer is the printable layer and will therefore be the external surface of any corrugate board construction made from the corrugate board described. The first outer layer 4 is not regarded as a printable layer as it will be too degraded for printing.

In the corrugate board field, flat sheets of corrugate are used. The present inventors have sought, contrary to the usual thinking, to produce a corrugate board suitable for use in forming curved constructions.

In seeking to produce a curved corrugate board construction, the present inventors attempted to curve the corrugate board 2 with the axis of curvature perpendicular to the direction of the flutes and with the second outer layer as the external face. That is the second outer layer 8 was on the outside of the convex curve of the curved board. In doing so, the present inventors noted to their surprise that creases were forming in the board 2 perpendicular to the flute direction and at regular intervals. After much investigation, these creases were traced back to the manufacturing process and to vacuum lines used in the application of the first outer layer 4 to the flute layer 6.

Counter intuitively, the present inventors now propose to make the first outer layer, which is the first layer secured to the flute layer, the final external layer of the corrugate board and, therefore the layer must be suitable for printing and is to be treated as the primary printable layer.

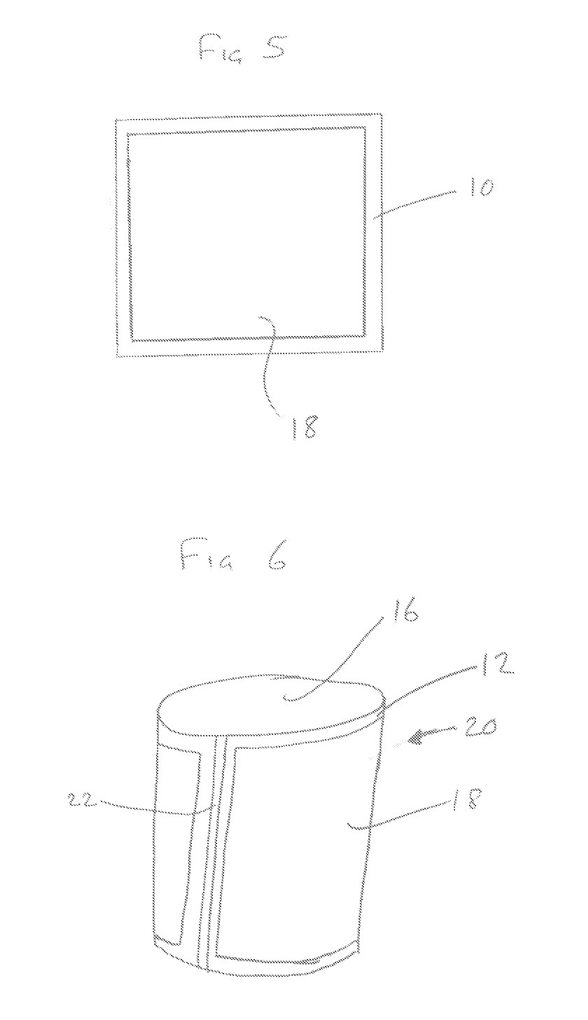

Referring to FIGS. 3 and 4 of the accompanying drawings, there is shown a corrugate board 10 of single wall construction according to the present invention comprising a first outer layer 12, a flute layer 14 and a second outer layer 16. The first outer layer 12 is the first layer secured to the flute layer 14 in the manufacturing process. The second outer layer 16 is the second layer secured to the flute layer 14 in the manufacturing process. In this case the board thickness is approximately 1 millimetre. The direction of the flutes is vertical in FIG. 3 and perpendicular to the plane of the paper in FIG. 4.

Referring to FIG. 5 of the accompanying drawings, there is shown the corrugate board 10 on which has been printed a desired printed layer 18 by, for instance flexography or lithography as is known in the art. However, the printed layer 18 is applied to the first outer layer 12. Although the applied print is shown as terminating before the edge of the corrugate board 10 for clarity, normally it will extend to the edge thereof.

Referring to FIG. 6 of the accompanying drawings, there is shown a corrugate board construction 20 comprising a single board joined at 22 to form an oval shape in cross-section. The board becomes part of a construction 20 when it is joined to itself or another component to form a non-planar construction. The manner of the join is immaterial to the present invention and many techniques exist for achieving this, some with adhesives, some with folds and some with interlocking elements such as tongue and slot arrangements.

The corrugate board construction 20 comprises a corrugate board 10 with a printed 18 external face. The corrugate board 10 is curved so that the axis of curvature is perpendicular to the flute direction. That is the axis of curvature is essentially vertical and the flute direction is horizontal. The external face of the corrugate board 10 is the first outer layer 12 such that the first outer layer 12 forms the convex outer of the construction and the second outer layer 16 forms the internal face of the construction.

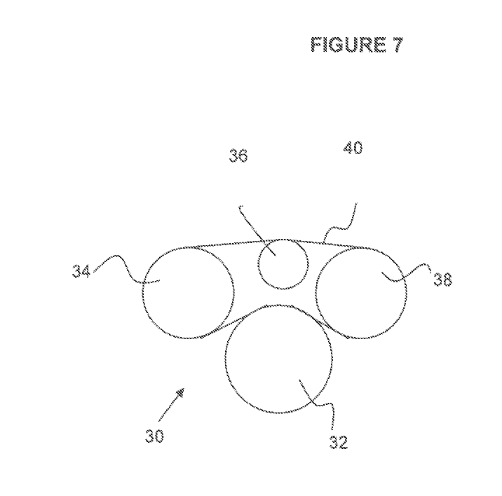

Referring to FIGS. 7-9 of the accompanying drawings, a method of manufacture of a corrugated board according to the present invention will now be described.

Referring to FIG. 7 of the accompanying drawings there is shown a modul facer bandleader 30 comprising a corrugated roll 32, a tension/heated roll 34, a guide roll 36 and a heated roll 38. Around the tension/heated roll 34, guide roll 36 and heated roll 38 runs a steel mesh pressure belt 40. This provides a belt pressure arrangement for applying distributed pressure across the contact area between the belt 40 and corrugated roll 32, thus enabling lower overall pressure than a nip roller arrangement.

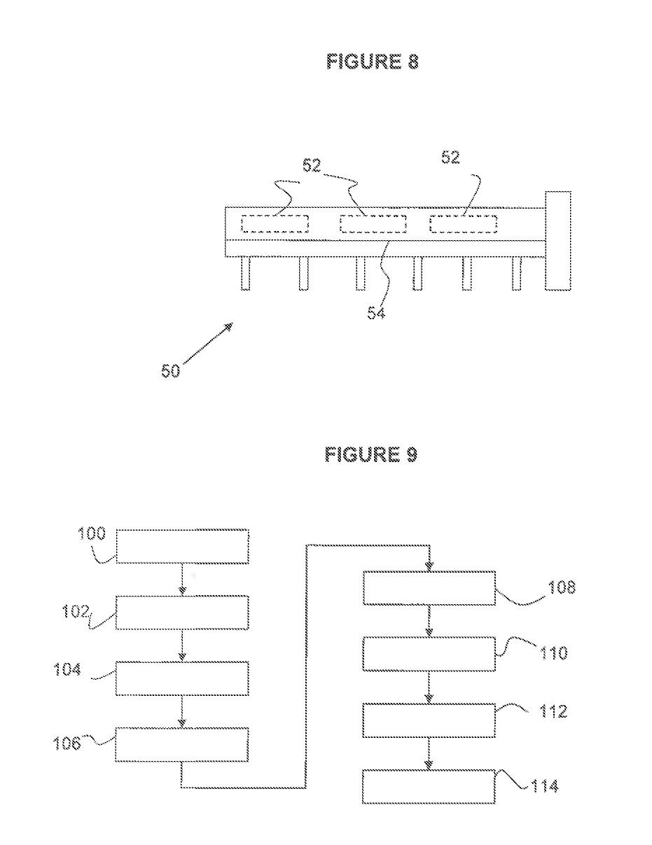

Referring to FIG. 8 of the accompanying drawings there is shown a double facer unit 50 of conventional construction and, accordingly, a detailed description thereof will be omitted. An example of a suitable double facer unit 50 is that available from BHS Services GmbH & Co KG. The double facer unit 50 comprises a plurality of upper heated plates 52 and a lower traction belt 54.

Referring to FIG. 9 of the accompanying drawings, in step 100 a first outer layer 12 is provided. This will normally be a coated paper, the coating providing a suitable substrate for printing. A suitable coated paper is 210 grams per square metre SERVIFLEX, a full clay coated white lined chip board which carries a printable coating on one side. It is 230 microns thick. The coating weight on the liner is 20 g/m².

In step 102 a flute layer 14 is provided which for this embodiment of the invention is G-flute.

In step 104 the first outer layer 12 has glue applied to it from a glue station (not shown), then the first outer layer 12, which is unheated, and the flute layer 14 are provided to and run through the modul facer bandleader 30 with the coated side away from the flute layer 14. The combined first outer layer 12 and flute layer 14 are pre-heated to 95° C. This secures the first outer layer 12 to the flute layer 14. By using the band pressure arrangement localised pressure is substantially reduced and the coated first outer layer 12 although affected in terms of macro-roughness, is still eminently suitable for printing.

Next, in step 106, a second outer layer 16 is provided. In this embodiment the second outer layer is a white top craft paper generally unsuitable for printing of 125 g/m² weight. Thus the first outer layer 12 is substantially denser than the second outer layer 16.

In step 108 glue is provided to the second outer layer 16 from a glue station (not shown) which layer 16 is then provided to the flute layer side of the now two-layer combined flute layer 14 and first outer layer 12 onto the double facer shown in FIG. 8 and described above. The second outer layer 16 is unheated, in contrast to conventional manufacturing techniques.

In step 110, the now three-layer material is provided to double facer unit 50 with the first outer layer 12 faced down against the lower traction belt 54. Heated plates 52 are used to cure the glue (starch) to secure the second outer layer 12 to the flute layer 14. The double facer unit 50 includes three separate heater run at 3 bar, 3 bar and 2 bar pressure respectively, equating to temperatures of 134° C., 134° C. and 121° C., respectively. This contrasts positively with the generally minimum 180° C. at which the heaters are run in a conventional process and as a result the cooling time (step 112) for the corrugate board according to the present invention is just about 24 hours instead of the typical 3 days of the conventional process.

Usually after slicing, the corrugate board is printed, in step 114, using a lithographic or flexographic process onto the exterior of the first outer layer 12 which can then be used as the exterior of a corrugate board construction such as the carton shown in FIG. 6.

In an alternative embodiment a printed lined version can be provided. In a post corrugate manufacturing printing step, a printed liner is applied to the first outer layer. Thus the printed layer forms a secondary exterior layer applied to the first outer layer curved, in the corrugate construction, in a convex manner.

The first outer layer is the direct layer to the band leader which is easily distinguishable by bending the material to highlight the corrugated flute profile vacuum slot lines. these ones are perpendicular to the standard flute lines. These lines are never visible on the second outer layer applied at the double backer section down stream on the corrugator. Thus the first outer layer is always easily distinguishable to a person skilled in the art.

Preferred embodiments of the present invention enable a corrugate board to be constructed that can be used in a curved corrugate board construction and, furthermore, with the first outer layer being able to act as the printable layer.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

We Claim:

1. A corrugate board construction comprising a first outer layer, a flute layer and a second outer layer, wherein the second outer layer has been secured to the flute after the first outer layer, wherein the external layer is the first outer layer.

2. The corrugate board construction of claim 1, wherein the flute layer has a flute direction construction the axis of curvature is perpendicular to the flute direction.

3. The corrugate board construction of claim 1, wherein the corrugate board construction is a box, tube or carton construction.

4. The corrugate board construction of claim 1, wherein the first outer layer is substantially denser than the second outer layer.

5. The corrugate board construction of claim 1, wherein the first outer layer at least 50 g/m² denser than the second outer layer.

6. The corrugate board construction of claim 5, wherein the first outer layer is at least 60 g/m² denser than the second outer layer.

7. The corrugate board construction of claim 5, wherein the first outer layer is at least 70 g/m² denser than the second outer layer.

8. The corrugate board construction of claim 5, wherein the first outer layer is at least 80 g/m² denser than the second outer layer.

9. A method of construction of a corrugate board construction, the method comprising the steps of:
a) providing a first outer layer;
b) providing a flute layer;
c) providing a second outer layer;
d) securing the first outer layer to the flute layer;
e) after the first outer layer is secured to the flute layer, securing the second outer layer to the flute layer; and
f) using the corrugate board to construct a corrugate board construction.

10. A corrugate board comprising a first outer layer, a flute layer and a second outer layer, wherein the second outer layer has been secured to the flute after the first outer layer and the first outer layer is suitable for printing.

11. The corrugate board of claim 10, wherein the first outer layer is the primary printable layer.

12. The corrugate board of claim 10, wherein the first outer layer comprises a printable coating.

13. The corrugate board of claim 10, wherein the first outer layer further comprises a printed layer applied thereto.

14. The corrugate board of claim 10, wherein the flute layer is G flute.

15. A method of construction of a corrugate board, the method comprising the steps of:
a) providing a first outer layer, which is a layer suitable for printing;
b) providing a flute layer;
c) providing a second outer layer;
d) securing the first outer layer to the flute layer; and
e) after the first outer layer is secured to the flute layer, securing the second outer layer to the flute layer.

16. The method of construction of a corrugate board of claim 15, wherein the method further comprises printing a layer onto the first outer layer.

17. The method of construction of a corrugate board of claim 15, wherein the method comprises securing the first outer layer to the flute layer in a distributed pressure process.

18. The method of construction of a corrugate board of claim 17, wherein the first outer layer is secured to the flute layer by the application of pressure from a pressure belt and a corrugated roller.

19. The method of construction of a corrugate board of claim 18, wherein the pressure belt extends between at least two rollers.

20. The method of construction of a corrugate board of claim 15, wherein the first outer layer is not heated to beyond ambient temperature before being provided to the flute layer.

21. The method of construction of a corrugate board of claim 15, wherein the second outer layer is secured to the flute layer at a heater temperature not exceeding 170° C.

22. The method of construction of a corrugate board of claim 21, wherein the second outer layer is secured to the flute layer at a heater temperature not exceeding 160° C.

23. The method of construction of a corrugate board of claim 22, wherein the second outer layer is secured to the flute layer at a heater temperature not exceeding 150° C.

24. The method of construction of a corrugate board of claim 23, wherein the second outer layer is secured to the flute layer at a heater temperature not exceeding 140° C.

25. The method of construction of a corrugate board of claim 15, wherein the corrugate board is left to dry for less than 3 days.

26. The method of construction of a corrugate board of claim 25, wherein the corrugate board is left to dry for less than 2% days.

27. The method of construction of a corrugate board of claim 26, wherein the corrugate board is left to dry for less than 2 days.

28. The method of construction of a corrugate board of claim 27, wherein the corrugate board is left to dry for less than 1½ days.

29. The method of construction of a corrugate board of claim 15, wherein the corrugate board is used for construction of a corrugate board construction.
